(19) United States
(12) Patent Application Publication
(10) Pub. No.: US 2026/0168914 A1
(43) Pub. Date: Jun. 18, 2026

(54) APPARATUS FOR DETECTING CORROSION RATE OF SOIL-COVERED STORAGE TANK AFTER CATHODIC PROTECTION

(71) Applicant: China Construction Industrial & Energy Engineering Group Co., Ltd., Nanjing (CN)

(72) Inventors: Jie LIU, Nanjing (CN); Changsha LIU, Nanjing (CN); Yi LI, Nanjing (CN); Zhongwu FAN, Nanjing (CN); Jian QIN, Nanjing (CN)

(73) Assignee: China Construction Industrial & Energy Engineering Group Co., Ltd., Nanjing (CN)

(21) Appl. No.: 19/396,409

(22) Filed: Nov. 21, 2025

Related U.S. Application Data
(63) Continuation of application No. PCT/CN2025/133246, filed on Nov. 7, 2025.

(30) Foreign Application Priority Data
Dec. 3, 2024 (CN) 2024117552756

(51) Int. Cl. G01N 17/02; C23F 13/22; G01N 17/00

(52) U.S. Cl. CPC G01N 17/02; C23F 13/22; G01N 17/006; C23F 2213/32

(57) ABSTRACT

Disclosed is an apparatus for detecting a corrosion rate of a soil-covered storage tank after cathodic protection in the technical field of detection equipment for measuring electrical variables, including: a tank body, a guard plate, bases symmetrically and fixedly connected to both bottom sides of the tank body, spherical heads fixedly connected to both ends of the tank body, a corrosion rate detection mechanism, and a computing chip, where guide rails are symmetrically and fixedly connected to an inner side of the guard plate, limit plates are fixedly connected to both ends of the guide rails, a threaded rod is rotatably connected between the two limit plates, guide rods are symmetrically arranged on an outer side of the threaded rod, a moving plate is threadedly connected to the outer side of the threaded rod, the threaded rod is fixedly connected to an output end of a motor.

### CROSS-REFERENCE TO RELATED APPLICATIONS

The application claims priority to Chinese patent application No. 2024117552756, filed on Dec. 3, 2024, the entire contents of which are incorporated herein by reference.

### TECHNICAL FIELD

This disclosure relates to the technical field of detection equipment for measuring electrical variables and, in particular, to an apparatus for detecting a corrosion rate of a soil-covered storage tank after cathodic protection.

### BACKGROUND

Storage tanks, as important industrial equipment, are widely used in petroleum, chemical, and other fields. To prevent accidents such as leakage during the use of a storage tank, cathodic protection technology is typically employed for anti-corrosion treatment of the storage tank. Cathodic protection works by applying an appropriate current to the surface of the storage tank to inhibit the occurrence of corrosion reactions, thereby achieving the goal of extending the storage tank's service life. However, after long-term operation, varying degrees of corrosion can still occur on the surface of the storage tank. If the corrosion is not detected promptly and no effective measures are taken, it may threaten the safety of the storage tank and cause serious environmental pollution accidents.

To monitor the corrosion status of storage tanks in a timely manner, electrochemical detection technologies such as the potential shift method and electrochemical noise method are commonly used in the prior art. The potential-shift method is used to assess the degree of corrosion by detecting changes in the corrosion potential of a metal surface, but it is significantly affected by factors such as ambient temperature and humidity, making it difficult to obtain accurate corrosion indicators. The electrochemical noise method is used to analyze the corrosion situation by using tiny current and potential fluctuation signals generated by corrosion reactions on a metal surface, but it suffers from low instrument sensitivity and cannot monitor subtle corrosion changes. Furthermore, most of these existing technologies employ point-based detection methods, which can only acquire corrosion information from individual parts of storage tanks and struggle to comprehensively reflect the overall corrosion status of the storage tanks.

Meanwhile, most existing detection equipment is installed outside the tank body, making real-time monitoring of buried or soil-covered storage tanks very difficult. This requires the detection equipment to possess certain characteristics such as waterproofing, dust resistance, and pressure resistance to adapt to complex underground environments. However, the existing detection equipment generally has a large size, and its installation and maintenance are relatively inconvenient, limiting its application in soil-covered storage tanks.

Therefore, there is an urgent need for an apparatus for detecting a corrosion rate of a soil-covered storage tank after cathodic protection, which can comprehensively and accurately monitor the corrosion situation of the storage tank in real time, thereby providing technical support for the safety assessment and maintenance of storage tanks.

### SUMMARY

In view of the foregoing, this disclosure provides an apparatus for detecting a corrosion rate of a soil-covered storage tank after cathodic protection, which is capable of solving the technical problem that most existing technologies can only acquire corrosion information from individual parts of storage tanks and struggle to comprehensively reflect the overall corrosion status of the storage tanks due to employing point-based detection methods.

This disclosure is achieved as follows:

an apparatus for detecting a corrosion rate of a soil-covered storage tank after cathodic protection, including: a tank body, a guard plate having a rectangular cuboid structure, bases symmetrically and fixedly connected to both bottom sides of the tank body, spherical heads fixedly connected to both ends of the tank body, a corrosion rate detection mechanism, and a computing chip, where guide rails are symmetrically and fixedly connected to an inner side of the guard plate, limit plates are fixedly connected to both ends of the guide rails, a threaded rod is rotatably connected between the two limit plates, guide rods are symmetrically arranged on an outer side of the threaded rod, a moving plate is threadedly connected to the outer side of the threaded rod, the threaded rod is fixedly connected to an output end of a motor, the motor is fixedly connected to an inner top wall of the guard plate, the corrosion rate detection mechanism is arranged on one side of the moving plate, the computing chip is arranged inside the guard plate and is electrically connected to the corrosion rate detection mechanism, and a corrosion rate computing module is arranged in the computing chip for computing the corrosion rate according to parameters collected by the corrosion rate detection mechanism and a preset mathematical model.

Based on the above technical solution, the apparatus for detecting the corrosion rate of the soil-covered storage tank after cathodic protection according to this disclosure can be further improved as follows:

the corrosion rate computing module is configured to execute the following steps:
S10: measuring electrochemical parameters on the surface of the tank body through the electrode sensor to obtain a potential value, a current density value, and a metal ion concentration value;
S20: establishing an electrochemical model of corrosion, and computing a corrosion reaction rate constant according to the potential value, the current density value, and the metal ion concentration value;
S30: acquiring environmental parameters, including soil resistivity, moisture content, pH, and redox potential;
S40: establishing an environmental correction factor computing model according to the environmental parameters;
S50: establishing a corrosion rate computing model, and combining the corrosion reaction rate constant with an environmental correction factor;
S60: computing an instantaneous corrosion rate according to the corrosion rate computing model;
S70: performing smoothing processing on the instantaneous corrosion rate using a moving time window method to obtain a steady-state corrosion rate;
S80: computing a corrosion depth according to the steady-state corrosion rate, and performing a corrosion warning judgment; and
S90: updating a historical database for subsequent corrosion trend analysis.

A computing model for the corrosion reaction rate constant is specifically expressed as follows:

$$k = {k}_{0} exp ( - \frac{Δ G}{R T} ) \cdot \frac{i}{nF} ;$$

where k represents the corrosion reaction rate constant, expressed in mm/year; k₀ represents a pre-exponential factor, with a value range of 10⁵ to 10⁷; ΔG represents an activation energy, expressed in J/mol; R represents a gas constant, with a value of 8.314 J/(mol·K); T represents an absolute temperature, expressed in K; i represents a current density, expressed in A/m²; n represents the number of transferred reaction electrons; F represents the Faraday constant, with a value of 96,485 C/mol.

The environmental correction factor computing model is specifically expressed as follows:

$$α = {β}_{1} \cdot exp ( - \frac{ρ}{{ρ}_{0}} ) + {β}_{2} \cdot {( \frac{H}{{H}_{0}} )}^{2} + {β}_{3} \cdot \frac{\vert pH - {pH}_{0} \vert}{{pH}_{0}} + {β}_{4} \cdot \frac{E - {E}_{0}}{{E}_{0}} ;$$

where α represents the environmental correction factor; ρ represents the soil resistivity, expressed in Ω·m; ρ₀ represents a standard soil resistivity, with a value of 1,000Ω·m; H represents the soil moisture content, expressed in %; H₀ represents a standard soil moisture content, with a value of 20%; pH represents the soil pH; pH₀ represents a standard soil pH, with a value of 7; E represents the redox potential, expressed in V; E₀ represents a standard redox potential, with a value of 0.4 V; and β₁, β₂, β₃, and β₄ represent weighting coefficients, obtained through experimental calibration.

The corrosion rate computing model is specifically expressed as follows:

$$v = k \cdot α \cdot ( 1 - η \cdot \frac{{E}_{cp}}{{E}_{c o r r}} ) ;$$

where v represents the corrosion rate, expressed in mm/year; E_{cp} represents a cathodic protection potential, expressed in V; E_{corr} represents a free corrosion potential, expressed in V; and η represents a cathodic protection efficiency coefficient, with a value range of 0 to 1.

The steady-state corrosion rate is computed by the moving time window method, specifically expressed as follows:

$${v}_{s} ( t ) = \frac{1}{N} {\sum }_{i = 0}^{N - 1} v ( t - i Δ t ) ;$$

where vₛ(t) represents a steady-state corrosion rate at a time point t; N represents a time window length; and Δt represents a sampling time interval, expressed in hours.

A computing model for the corrosion depth is specifically expressed as follows:

$$d ( t ) = {\int }_{0}^{t} {v}_{s} ( τ ) d τ ;$$

where d(t) represents a corrosion depth at the time point t, expressed in mm; and τ represents a variable of integration.

A calibration method for the weighting coefficients β₁, β₂, β₃, and β₄ is as follows:
1: conducting comparative tests in different soil environments;
2: measuring actual corrosion rates of test samples; and
3: obtaining the weighting coefficients by fitting using the least squares method.

The corrosion rate detection mechanism includes a threaded sleeve having a cylindrical structure, a threaded seat is threadedly connected inside the threaded sleeve, an extension rod is rotatably connected to a central position inside the threaded seat, an arc-shaped plate is fixedly connected to one end of the extension rod and has an arc-shaped structure and an inner arc-shaped surface matching an outer surface of the tank body, an electrode sensor and a cleaning brush are fixedly connected to an inner side of the arc-shaped plate, and the electrode sensor is configured to detect a corrosion potential and current density on a surface of the tank body.

Further, a cathodic protector, configured to provide a cathodic protection current to the tank body, is fixedly connected to one side of the spherical heads and is electrically connected to an external power supply via a waterproof cable, a pipeline is fixedly connected to a lower end of one side of the spherical heads, and a gas concentration detector is fixedly connected to one end of the pipeline.

Further, the guide rods are fixedly connected between the two limit plates and have a cylindrical structure with smooth surfaces, while the moving plate is slidably connected to an outer side of the guide rods and slidably engages with the guide rods through built-in bearings.

Further, sealing strips made of rubber material are arranged on both sides of the guard plate and closely adhere to the outer surface of the tank body, while the guard plate is fixed to the ground by fixing bolts and matches the tank body in length.

Further, a limit protrusion is arranged on an outer side of the threaded sleeve, a limit groove cooperating with the limit protrusion is arranged on the moving plate, and the limit protrusion and the limit groove cooperate to prevent rotation of the threaded sleeve.

Further, the motor is a stepper motor with an adjustable rotational speed, the stepper motor is fixed to an inner wall of the guard plate via a motor mount, the motor mount employs an anti-vibration structure, and a coupling is arranged between an output shaft of the stepper motor and the threaded rod.

Further, the bases employ a reinforced concrete structure, an anti-slip pattern is arranged on top surfaces of the bases, the bases are fixedly connected to the ground by expansion bolts, and a height of the bases is not less than 50 cm.

Further, the cleaning brush includes a brush body having a rectangular cuboid structure, and bristles uniformly distributed on a surface of the brush body, where the bristles are made of corrosion-resistant nylon material, the brush body is fixedly connected to an inner surface of the arc-shaped plate by screws, and a length of the bristles is set according to a roughness of the surface of the tank body.

Compared with the prior art, the apparatus for detecting the corrosion rate of the soil-covered storage tank after cathodic protection provided by this disclosure has the following beneficial effects:

1. Comprehensive monitoring: the detection apparatus of this disclosure employs an integrated detection method. By arranging dense detection mechanisms on the surface of the tank body, it can comprehensively acquire corrosion status information of the storage tank, rather than being limited to individual parts. Compared with the existing point-based detection technology, it can more accurately reflect the overall corrosion condition of the storage tank.

2. High-precision analysis: the detection apparatus of this disclosure combines electrochemical measurements and corrosion model analysis, enabling accurate computing of key indicators such as the instantaneous corrosion rate, the steady-state corrosion rate, and the corrosion depth. These indicators can not only reflect the current corrosion status but also predict future corrosion trends, providing a basis for the maintenance of the storage tank. Compared with the prior art, which can only obtain single pieces of information such as corrosion potential or current, the analytical method of this disclosure is more comprehensive and accurate.

3. Strong applicability: the detection apparatus of this disclosure is specifically designed for soil-covered storage tanks. It employs a waterproof and pressure-resistant mechanical structure capable of adapting to complex underground environments, solving the problem faced by the prior art in monitoring buried or soil-covered storage tanks. Furthermore, the apparatus has a relatively small size, facilitating installation and maintenance, making its widespread application in practical engineering feasible.

4. Intelligence: the detection apparatus of this disclosure is equipped with a microprocessor chip, enabling automatic detection, analysis, and warning functions for the corrosion status. Detection data can be uploaded to a monitoring center in real-time, providing decision-making support for management personnel. This level of intelligence is higher than that of the manual inspection mode in the prior art.

To sum up, the apparatus for detecting the corrosion rate of the soil-covered storage tank after cathodic protection proposed by this disclosure shows significant improvements in comprehensive monitoring, high-precision analysis, applicability, and intelligence. It provides an effective technical means for improving the safety of the storage tank and extending its service life, thereby solving the technical problem that most of the existing technologies can only acquire corrosion information from individual parts of storage tanks and struggle to comprehensively reflect the overall corrosion status of the storage tanks due to employing point-based detection methods.

### BRIEF DESCRIPTION OF THE DRAWINGS

FIG. 1 is a schematic structural diagram of an apparatus for detecting a corrosion rate of a soil-covered storage tank after cathodic protection proposed by this disclosure;

FIG. 2 is a schematic cross-sectional diagram of the apparatus;

FIG. 3 is a schematic diagram of an internal structure of the apparatus;

FIG. 4 is a schematic diagram of an electrode-related structure;

FIG. 5 is a schematic structural diagram of a limit plate;

FIG. 6 is a schematic diagram of an extension rod-related structure;

FIG. 7 is a flowchart of steps executed by a corrosion rate computing module;

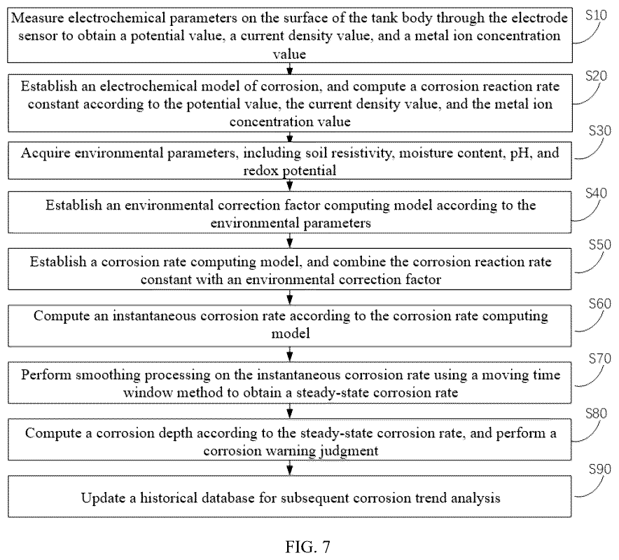

FIG. 8 is a curve graph showing the variation of the surface potential value of the storage tank over time;

FIG. 9 is a graph showing a variation trend of the corrosion rate of the storage tank; and

FIG. 10 is a graph showing a variation trend of the corrosion depth of the storage tank;

where: 1—leveled ground; 2—tank body; 3—spherical head; 4—base; 5—cleaning brush; 6—cathodic protector; 7—pipeline; 8—gas concentration detector; 9—guard plate; 10—guide rail; 11—limit plate; 12—threaded rod; 13—guide rod; 14—moving plate; 15—motor; 16—threaded sleeve; 17—threaded seat; 18—extension rod; 19—arc-shaped plate; and 20—electrode sensor.

### DETAILED DESCRIPTION OF THE EMBODIMENTS

To make the objectives, technical solutions, and advantages of the embodiments of this disclosure clearer, the technical solutions in the embodiments of this disclosure will be described clearly and completely below with reference to the accompanying drawings in the embodiments of this disclosure.

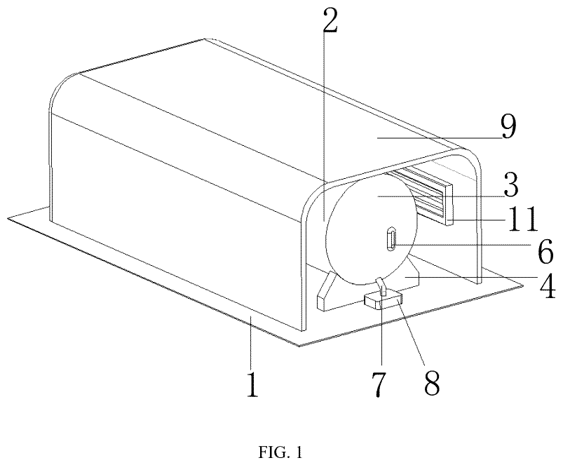

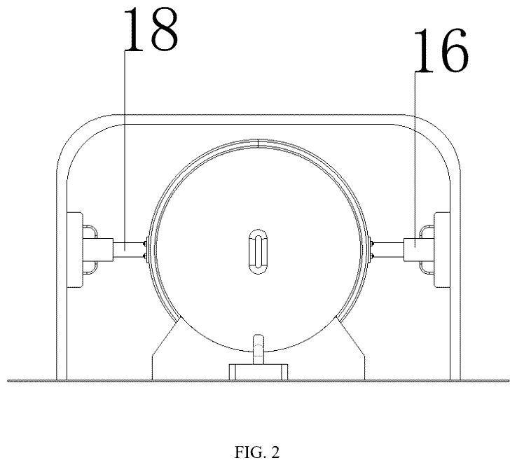

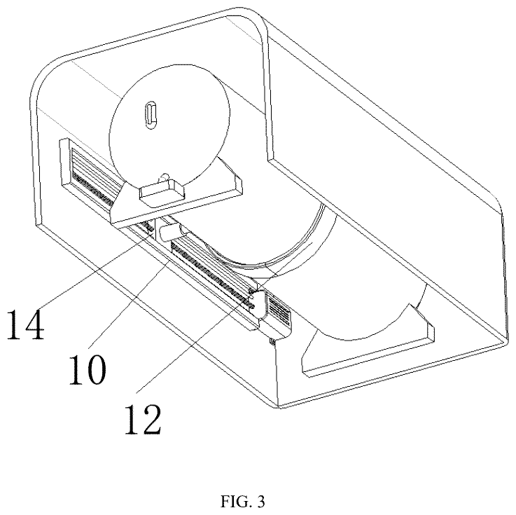

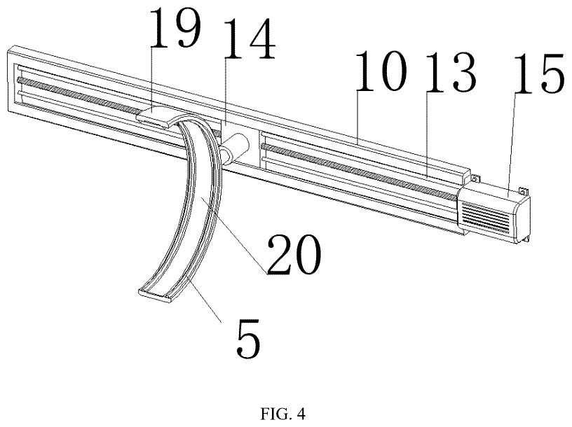

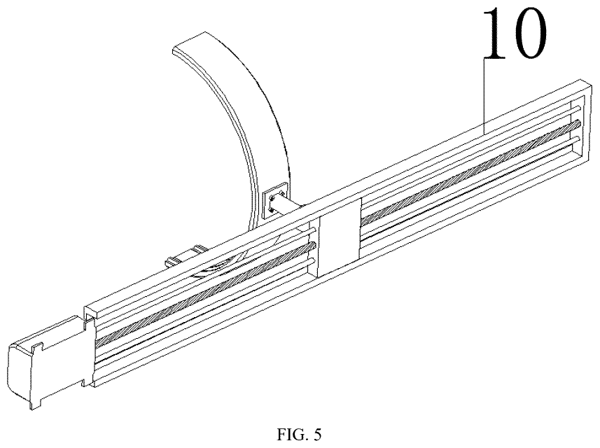

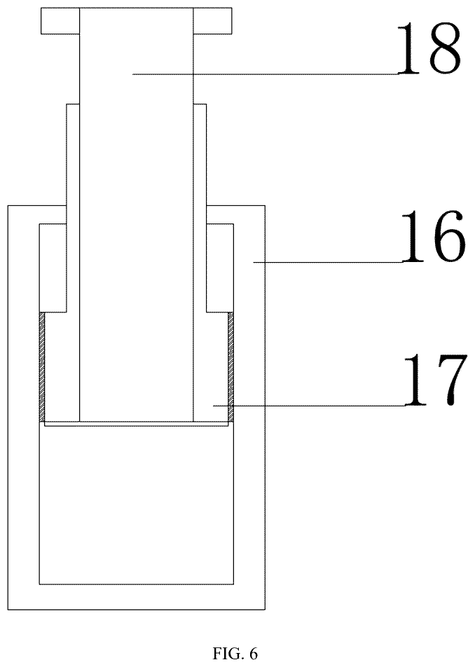

As shown in FIGS. 1-6, which are schematic structural diagrams of an apparatus for detecting a corrosion rate of a soil-covered storage tank after cathodic protection provided by this disclosure, the apparatus includes: a tank body 2, a guard plate 9 having a length of 76 m, bases 4 symmetrically and fixedly connected to both bottom sides of the tank body 2, and spherical heads 3 fixedly connected to both ends of the tank body 2, where guide rails 10 are symmetrically and fixedly connected to an inner side of the guard plate 9, the length of the guard plate 9 and internal components are consistent with a length of the soil-covered storage tank, limit plates 11 are fixedly connected to both ends of the guide rails 10, a threaded rod 12 is rotatably connected between the two limit plates 11, guide rods 13 are symmetrically arranged on an outer side of the threaded rod 12, a moving plate 14 is threadedly connected to the outer side of the threaded rod 12, the threaded rod 12 is fixedly connected to an output end of a motor 15, and a corrosion rate detection mechanism is arranged on one side of the moving plate 14. During the installation process, the soil-covered storage tank is first positioned and installed, and then the guard plate 9 is installed on an outer side of the soil-covered storage tank, with its length being set according to the length of the storage tank. By driving the motor 15, the moving plate 14 is caused to move horizontally under the threaded rotation of the threaded rod 12, thereby cooperating with the corrosion rate detection mechanism to perform mobile detection on the surface of the tank body 2. An extension rod 18 and an arc-shaped plate 19 arranged in the corrosion rate detection mechanism are adjustable structures. By rotating a threaded seat 17 arranged on an outer side of the extension rod 18, the extension rod 18 is pushed under the threaded rotation of the threaded sleeve 16 and the threaded seat 17 to make the arc-shaped plate 19 fit against the surface of the storage tank, thereby making a cleaning brush 5 fit more closely to the surface of the storage tank. Thus, the corrosion efficiency can be determined by measuring parameters such as corrosion potential and current density. Consequently, the method of mobile detection can reduce the number of electrode sensors required for installation, thereby reducing costs while also improving detection efficiency. The apparatus further includes a computing chip arranged inside the guard plate and electrically connected to the corrosion rate detection mechanism, where a corrosion rate computing module is arranged in the computing chip for computing the corrosion rate according to parameters collected by the corrosion rate detection mechanism and a preset mathematical model.

The corrosion rate computing module is configured to execute the following steps:
S10: measuring electrochemical parameters on the surface of the tank body through the electrode sensor to obtain a potential value, a current density value, and a metal ion concentration value;
S20: establishing an electrochemical model of corrosion, and computing a corrosion reaction rate constant according to the potential value, the current density value, and the metal ion concentration value;
S30: acquiring environmental parameters, including soil resistivity, moisture content, pH, and redox potential;
S40: establishing an environmental correction factor computing model according to the environmental parameters;
S50: establishing a corrosion rate computing model, and combining the corrosion reaction rate constant with an environmental correction factor;
S60: computing an instantaneous corrosion rate according to the corrosion rate computing model;
S70: performing smoothing processing on the instantaneous corrosion rate using a moving time window method to obtain a steady-state corrosion rate;
S80: computing a corrosion depth according to the steady-state corrosion rate, and performing a corrosion warning judgment; and
S90: updating a historical database for subsequent corrosion trend analysis.

Preferably, both the tank body 2 and the bases 4 are located on top of a leveled ground 1.

Preferably, a cathodic protector 6 is fixedly connected to one side of the spherical heads 3.

Preferably, a pipeline 7 is fixedly connected to a lower end of one side of the spherical heads 3, and a gas concentration detector 8 is fixedly connected to one end of the pipeline 7.

Preferably, the guide rods 13 are fixedly connected between the two limit plates

11.

Preferably, the moving plate 14 is slidably connected to an outer side of the guide rods 13.

Preferably, the motor 15 is fixedly connected inside the guard plate 9.

Preferably, the corrosion rate detection mechanism includes a threaded sleeve 16, where a threaded seat 17 is threadedly connected inside the threaded sleeve 16, an extension rod 18 is rotatably connected inside the threaded seat 17, an arc-shaped plate 19 is fixedly connected to one end of the extension rod 18, and an electrode sensor 20 and a cleaning brush 5 are fixedly connected to an inner side of the arc-shaped plate 19. The provided cleaning brush 5, driven by the motor 15, slides on the surface of the tank body 2 for cleaning, and it is capable of wiping away adhered moisture on the surface. The model of the electrode sensor 20 is Heraeus Palnesa 2.

Working principle and operational procedure of the apparatus: during use, the apparatus drives the moving plate 14 to move horizontally along the surface of the tank body 2 via the motor, cooperating with the corrosion rate detection mechanism to perform corrosion rate detection on the surface of the tank body; the motor 15 drives the threaded rod 12 to rotate, causing the moving plate 14 to move horizontally along the surface of the tank body 2 under the guidance of the guide rods 13; the extension rod 18 and the arc-shaped plate 19, through adjustment of the threaded seat 17, can fit against the surface of the tank body with different curvatures, ensuring good contact between the electrode sensor 20 and the surface of the tank body; the cleaning brush 5 moves with the moving plate 14, wiping away moisture and impurities adhering to the surface of the tank body, ensuring the measurement accuracy of the electrode sensor 20; the electrode sensor 20 measures parameters such as corrosion potential and current density on the surface of the tank body in real time; the corrosion rate computing module computes the corrosion rate of the tank body based on the measured parameters, combined with the material of the tank body and environmental parameters. Through mobile detection, the apparatus can reduce the number of electrode sensors required for installation, lower costs, and simultaneously improve detection efficiency. The cleaning brush 5 can remove impurities from the surface of the tank body, ensure the measurement accuracy of the electrode sensor 20, and improve detection precision. The apparatus is suitable for soil-covered storage tanks of different shapes and sizes and can adapt to different corrosive environments.

A detailed description of the specific implementation of the steps executed by the corrosion rate computing module is given below:

S10: measuring electrochemical parameters on the surface of the tank body through the electrode sensor to obtain a potential value V a current density value i, and a metal ion concentration value C. First, the electrode sensor is used to perform scanning measurements on the surface of the tank body to obtain the surface potential value V and the current density value i. The measured potential value V primarily reflects electrochemical potential changes during a corrosion reaction process, while the current density value i reflects the magnitude of the corrosion current. Second, an electrochemical analyzer is used to measure the metal ion concentration C at a measurement point. These electrochemical parameters form basic data for subsequent corrosion rate computing.

S20: establishing an electrochemical model of corrosion, and computing a corrosion reaction rate constant k according to the potential value V, the current density value i, and the metal ion concentration value C. According to the classical Butler-Volmer equation, the corrosion reaction rate constant k can be expressed as follows:

$$k = {k}_{0} exp ( - \frac{Δ G}{R T} ) \cdot \frac{i}{nF} ;$$

where k₀ represents a pre-exponential factor, with a value range of 10⁵ to 10⁷; ΔG represents an activation energy, expressed in J/mol; R represents a gas constant, with a value of 8.314 J/(mol·K); T represents an absolute temperature, expressed in K; i represents a current density, expressed in A/m²; n represents the number of transferred reaction electrons; F represents the Faraday constant, with a value of 96485 C/mol. Based on the kinetic process of a corrosion reaction, this model uses parameters such as the potential value V, the current density value i, and the metal ion concentration value C to compute the corrosion reaction rate constant k.

S30: acquiring environmental parameters, including soil resistivity p, moisture content H, pH, and redox potential E. First, a soil resistivity meter is used to measure the soil resistivity p, expressed in Ω·m. Then, a soil moisture content detector is used to measure the soil moisture content H, expressed in %. Next, a pH meter is used to measure the soil pH. Finally, a redox potential meter is used to measure the soil redox potential E, expressed in V. These environmental parameters reflect the soil corrosivity and are key factors for subsequent corrosion rate computing.

S40: establishing an environmental correction factor computing model α according to the environmental parameters. The environmental correction factor computing model α reflects the influence of a soil environment on the corrosion rate and can be expressed as follows:

$$α = {β}_{1} \cdot exp ( - \frac{ρ}{{ρ}_{0}} ) + {β}_{2} \cdot {( \frac{H}{{H}_{0}} )}^{2} + {β}_{3} \cdot \frac{\vert pH - {pH}_{0} \vert}{{pH}_{0}} + {β}_{4} \cdot \frac{E - {E}_{0}}{{E}_{0}} ;$$

where ρ₀ represents a standard soil resistivity, with a value of 1000Ω·m; H₀ represents a standard soil moisture content, with a value of 20%; pH₀ represents a standard soil pH, with a value of 7; E₀ represents a standard redox potential, with a value of 0.4 V; and β₁, β₂, β₃, and β₄ represent weighting coefficients, obtained through experimental calibration. This model can convert the measured environmental parameters into a corresponding environmental correction factor, providing a basis for subsequent corrosion rate computing.

S50: establishing a corrosion rate computing model, and combining the corrosion reaction rate constant k with an environmental correction factor α. The corrosion rate vcan be expressed as follows:

$$v = k \cdot α \cdot ( 1 - η \cdot \frac{{E}_{cp}}{{E}_{c o r r}} ) ;$$

where E_{cp} represents a cathodic protection potential, expressed in V; E_{corr} represents a free corrosion potential, expressed in V; and n represents a cathodic protection efficiency coefficient, with a value range of 0 to 1. This model multiplies the corrosion reaction rate constant by the environmental correction factor and considers influence factors of cathodic protection to obtain the final corrosion rate.

S60: computing an instantaneous corrosion rate v according to the corrosion rate computing model. By substituting the corrosion reaction rate constant k obtained in S20, the environmental correction factor α obtained in S40, and the cathodic protection parameters into the corrosion rate computing model, the instantaneous corrosion rate v at a current time point can be obtained. The instantaneous corrosion rate reflects the real-time corrosion status of the surface of the tank body and provides basic data for subsequent smoothing processing and corrosion depth computing.

S70: performing smoothing processing on the instantaneous corrosion rate v using a moving time window method to obtain a steady-state corrosion rate vₛ(t). The specific formula for the moving time window method is as follows:

$${v}_{s} ( t ) = \frac{1}{N} {\sum }_{i = 0}^{N - 1} v ( t - i Δ t ) ;$$

where vₛ(t) represents a steady-state corrosion rate at a time point t; N represents a time window length; and Δt represents a sampling time interval, expressed in hours. By averaging the instantaneous corrosion rate over a certain time range, this method can effectively filter out instantaneous fluctuations and obtain a smoother corrosion rate trend.

S80: computing a corrosion depth d according to the steady-state corrosion rate Us, and performing a corrosion warning judgment. The corrosion depth d can be expressed as follows:

$$d ( t ) = {\int }_{0}^{t} {v}_{s} ( τ ) d τ ;$$

by integrating the steady-state corrosion rate vₛ, the corrosion depth d at the current time point can be obtained. If the corrosion depth d exceeds a preset threshold, such as 5 mm, a corrosion warning is triggered so that protective measures can be taken promptly.

S90: updating a historical database for subsequent corrosion trend analysis. Data such as the instantaneous corrosion rate v computed in S60, the steady-state corrosion rate vₛ computed in S70, and the corrosion depth d computed in S80 are stored in the historical database in chronological order. These data can be used to analyze the long-term corrosion trend of the tank body, providing a basis for future maintenance and service.

Specifically, the principles of this disclosure are as follows:

1. Measurement of electrochemical parameters: the apparatus is provided with dense electrode sensors on the surface of the tank body, which are capable of measuring electrochemical parameters such as the potential value V, the current density value i, and the metal ion concentration value C in real time during the corrosion process. These parameters reflect the kinetic process of a corrosion reaction and form a basis for subsequent corrosion rate computing.

2. Computing of the corrosion reaction rate constant: based on the measured electrochemical parameters and combined with the Butler-Volmer equation, the corrosion reaction rate constant k can be computed. This constant describes the inherent kinetic characteristics of a corrosion reaction and is related to factors such as temperature and current density.

3. Modeling of the environmental correction factor: in addition to the inherent kinetic characteristics of the corrosion reaction, environmental factors such as soil resistivity, moisture content, pH, and redox potential also significantly influence the corrosion rate. Therefore, this disclosure establishes an environmental correction factor computing model α, which converts these environmental parameters into a corresponding correction factor, providing a basis for subsequent corrosion rate computing.

4. Comprehensive computing of the corrosion rate: finally, this disclosure proposes a corrosion rate computing model, which multiplies the corrosion reaction rate constant k obtained in the step 2 by the environmental correction factor α obtained in the step 3, and simultaneously considers the influence factors of cathodic protection to compute the instantaneous corrosion rate V. By applying moving time window smoothing processing to the instantaneous corrosion rate, the steady-state corrosion rate vₛ can be obtained, providing data support for corrosion depth computing and warning.

5. Intelligent monitoring and warning: the detection apparatus of this disclosure is equipped with a microprocessor chip, enabling it to automatically complete the aforementioned steps of electrochemical parameter measurement and corrosion rate computing, and upload the results to a monitoring center. Once it is detected that the corrosion depth exceeds a preset threshold, the system automatically issues a warning signal to alert management personnel to take necessary maintenance measures. This intelligent monitoring and warning function significantly improves the efficiency of storage tank safety management.

By integrating the aforementioned core technologies, the apparatus for detecting the corrosion rate of the soil-covered storage tank after cathodic protection according to this disclosure can comprehensively and accurately monitor the corrosion status of the storage tank in real time, thereby providing effective technical support for ensuring the safety of the storage tank and extending its service life. Its innovativeness is reflected in the full utilization of electrochemical measurements and kinetic models of corrosion to construct a complete intelligent corrosion status monitoring system, remedying the deficiencies of existing technologies in terms of detection accuracy, comprehensiveness, and applicability.

The following provides an embodiment of a specific application scenario of this disclosure: a soil-covered storage tank at a steel mill located in a coastal area has been operating for many years using cathodic protection technology. To monitor the corrosion status of the storage tank in real time, the enterprise decided to install and trial-run the apparatus for detecting the corrosion rate of the soil-covered storage tank after cathodic protection proposed by this disclosure.

The storage tank had a cylindrical structure with a diameter of 20 m, a length of 50 m, and a burial depth of 5 m. After a comprehensive inspection of the storage tank, 3 sets of the detection apparatus of this disclosure were installed at the upper, middle, and lower positions on the surface of the storage tank, respectively. Each set of the detection apparatus consisted of the tank body, the guard plate, the bases, the spherical heads, the corrosion rate detection mechanism, and the computing chip.

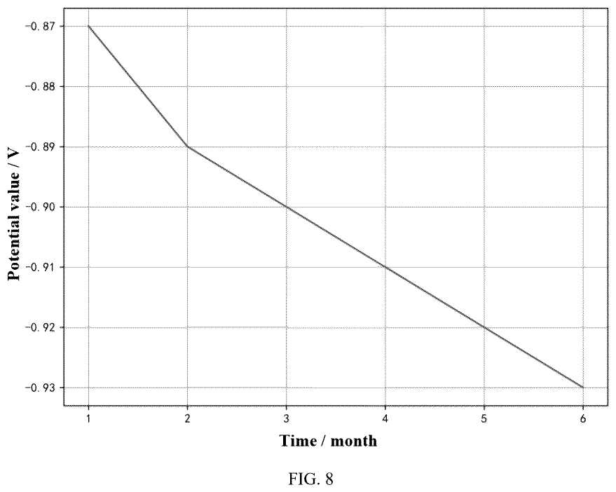

First, electrochemical parameters on the surface of the tank body were measured through the electrode sensor. As shown in FIG. 8, the detection results indicated that the potential value V on the surface of the tank body varied between −0.85 V and −0.92 V, the current density value i fluctuated between 0.12 A/m² and 0.22 A/m², and the metal ion concentration C was approximately 0.05 g/L. These parameters indicated that the surface of the storage tank was in an active corrosion state.

Second, the corrosion reaction rate constant k was computed based on the measured electrochemical parameters. Assuming the pre-exponential factor k₀ was 10⁶, the activation energy ΔG was 40 J/mol, the temperature T was 298 K, and the number of transferred electrons n was 2, then:

$$k = 1 {0}^{6} exp ( - \frac{40000}{8 \text{.314} \cdot 298} ) \cdot \frac{0.17}{2 \cdot 96485} = 0.35 mm / year ;$$

This value indicated that under the current corrosive environmental conditions, the inherent corrosion reaction rate on the surface of the storage tank was relatively fast.

Next, the environmental parameters of the soil where the storage tank was located were measured: the resistivity ρ was 5000Ω·m, the moisture content H was 12%, the pH was 6.5, and the redox potential E was 0.32 V. These parameters were substituted into the environmental correction factor computing model, yielding:

$$α = 0.8 \cdot exp ( - \frac{500}{1000} ) + 1.2 \cdot {( \frac{12}{20} )}^{2} + 0.9 \cdot \frac{\vert 6.5 - 7 \vert}{7} + 1.1 \cdot \frac{0.32 - 0.4}{0.4} = 0 \text{.85} ;$$

this correction factor indicated that the current soil environment had a certain accelerating effect on the corrosion of the storage tank.

Then, the data obtained in the steps 2 and 3 were substituted into the corrosion rate computing model. Assuming the cathodic protection potential E_{cp} was −0.9 V, the free corrosion potential E_{corr} was −0.85 V, and the cathodic protection efficiency coefficient η was 0.8, the instantaneous corrosion rate v was computed as follows:

$$v = 0.35 \cdot 0.85 \cdot ( 1 - 0.8 \cdot \frac{- 0.9}{- 0.85} ) = 0.22 mm / year ;$$

this instantaneous corrosion rate reflected the real-time corrosion status of the surface of the storage tank at the current time point.

To further improve the stability of corrosion rate prediction, the moving time window method was used to perform smoothing processing on the instantaneous corrosion rate. Assuming the time window length N was 6 and the sampling time interval Δt was 2 h, the steady-state corrosion rate vₛ was computed as follows:

$${v}_{s} ( t ) = \frac{1}{6} {\sum }_{i = 0}^{5} v ( t - i \cdot 2 ) = 0.2 mm / year ;$$

by integrating the steady-state corrosion rate vₛ, the corrosion depth d at the current time point was obtained:

$$d ( t ) = {\int }_{0}^{t} {v}_{s} ( τ ) d τ = 1.2 mm ;$$

since this corrosion depth had not exceeded the preset threshold of 5 mm, the system did not trigger a corrosion warning.

To further analyze the long-term corrosion trend of the storage tank, the detection apparatus of this disclosure recorded and stored the aforementioned detection data in the historical database. Table 1 shows partial data over a 6-month period:

TABLE 1
Corrosion Detection Data of the Storage Tank

| | | | | Instantaneous | Steady-state | |
|---|---|---|---|---|---|---|
| | Potential | Current | Metal Ion | Corrosion | Corrosion | Corrosion |
| | Value | Density | Concentration | Rate v, | Rate vₛ, | Depth |
| Time | V, V | i, A/m² | C, g/L | mm/year | mm/year | d, mm |
| Apr. 1, 2024 | −0.87 | 0.15 | 0.04 | 0.19 | 0.18 | 0.72 |
| May 1, 2024 | −0.89 | 0.18 | 0.05 | 0.21 | 0.19 | 0.91 |
| Jun. 1, 2024 | −0.90 | 0.20 | 0.06 | 0.23 | 0.20 | 1.13 |
| Jul. 1, 2024 | −0.91 | 0.22 | 0.07 | 0.24 | 0.21 | 1.35 |
| Aug. 1, 2024 | −0.92 | 0.23 | 0.08 | 0.26 | 0.22 | 1.58 |
| Sep. 1, 2024 | −0.93 | 0.25 | 0.09 | 0.27 | 0.23 | 1.83 |

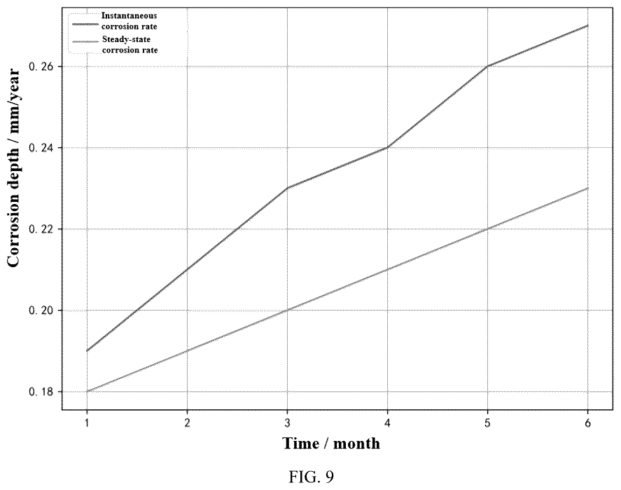

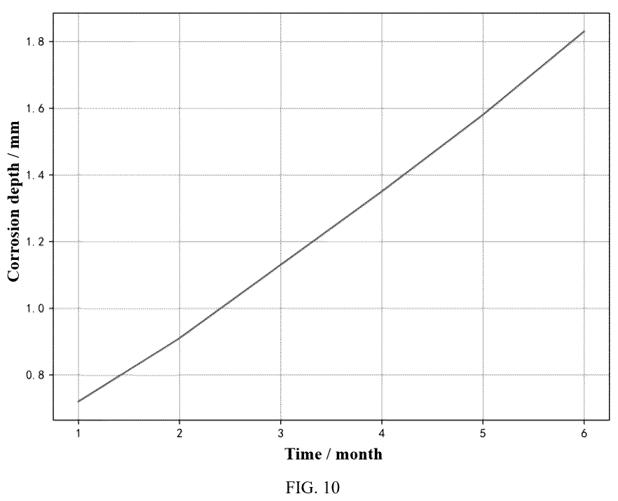

As can be seen from the data in Table 1, with increasing service time, the surface potential value V of the storage tank gradually declined, while the current density i and the metal ion concentration C also showed a rising trend, indicating that the corrosion problem was becoming increasingly severe. The computed instantaneous corrosion rate v and steady-state corrosion rate vₛ were also continuously rising, reflecting the intensification of the corrosion degree. As shown in FIG. 9, both the instantaneous corrosion rate v and the steady-state corrosion rate vₛ on the surface of the storage tank showed a rising trend over time, which was consistent with the declining trend of the potential value V. Finally, FIG. 10 shows the variation of the corrosion depth d of the storage tank: it clearly displays the growth of the corrosion depth d on the surface of the storage tank over time, gradually increasing from the initial 0.72 mm to 1.83 mm, already approaching the warning threshold of 5 mm.

Based on the aforementioned detection data and trend analysis, the following conclusions can be drawn:

1. The surface of the storage tank is in a severe corrosion state, and the corrosion problem is getting worse. The decrease in the potential value and the increase in the current density and metal ion concentration reflect the increasingly high activity of the corrosion reaction.

2. Both the instantaneous corrosion rate and the steady-state corrosion rate show a continuously rising trend, indicating that the corrosion rate is continuously accelerating. If no effective measures are taken, the service life of the storage tank will be significantly shortened.

3. The corrosion depth on the surface of the storage tank has already approached the warning threshold, and it is highly likely to exceed this threshold within the next six months. At that time, emergency maintenance measures must be taken to ensure the safe use of the storage tank.

Based on the above analysis results, the enterprise decided to carry out maintenance and repair of the storage tank as soon as possible, while strengthening the daily inspection and data analysis of the detection apparatus of this disclosure to provide reliable technical support for the safe operation of the storage tank.

To sum up, the apparatus for detecting the corrosion rate of the soil-covered storage tank after cathodic protection proposed by this disclosure can comprehensively and accurately monitor the corrosion status of the storage tank in real time, providing an effective technical means for ensuring the safety of the storage tank and extending its service life.

The above merely describes the embodiments of this disclosure, but the scope of protection of this disclosure is not limited thereto. Any changes or replacements that can be easily thought by those skilled in the art within the technical scope disclosed herein shall fall within the scope of protection of this disclosure.

What is claimed is:

1. An apparatus for detecting a corrosion rate of a soil-covered storage tank after cathodic protection, comprising: a tank body, a guard plate having a rectangular cuboid structure, bases symmetrically and fixedly connected to both bottom sides of the tank body, spherical heads fixedly connected to both ends of the tank body, a corrosion rate detection mechanism, and a computing chip, wherein guide rails are symmetrically and fixedly connected to an inner side of the guard plate, limit plates are fixedly connected to both ends of the guide rails, a threaded rod is rotatably connected between the two limit plates, guide rods are symmetrically arranged on an outer side of the threaded rod, a moving plate is threadedly connected to the outer side of the threaded rod, the threaded rod is fixedly connected to an output end of a motor, the motor is fixedly connected to an inner top wall of the guard plate, the corrosion rate detection mechanism is arranged on one side of the moving plate, the computing chip is electrically connected to the corrosion rate detection mechanism, and a corrosion rate computing module is arranged in the computing chip for computing the corrosion rate according to parameters collected by the corrosion rate detection mechanism and a preset mathematical model; the corrosion rate detection mechanism comprises a threaded sleeve having a cylindrical structure, a threaded seat is threadedly connected inside the threaded sleeve, an extension rod is rotatably connected to a central position inside the threaded seat, an arc-shaped plate is fixedly connected to one end of the extension rod and has an arc-shaped structure and an inner arc-shaped surface matching an outer surface of the tank body, an electrode sensor and a cleaning brush are fixedly connected to an inner side of the arc-shaped plate, and the electrode sensor is configured to detect a corrosion potential and current density on a surface of the tank body; a cathodic protector, configured to provide a cathodic protection current to the tank body, is fixedly connected to one side of the spherical heads and is electrically connected to an external power supply via a waterproof cable, a pipeline is fixedly connected to a lower end of one side of the spherical heads, and a gas concentration detector is fixedly connected to one end of the pipeline; and the corrosion rate computing module is configured to execute the following steps:
S10: measuring electrochemical parameters on the surface of the tank body through the electrode sensor to obtain a potential value, a current density value, and a metal ion concentration value;
S20: establishing an electrochemical model of corrosion, and computing a corrosion reaction rate constant according to the potential value, the current density value, and the metal ion concentration value;
S30: acquiring environmental parameters, comprising soil resistivity, moisture content, pH, and redox potential;
S40: establishing an environmental correction factor computing model according to the environmental parameters;
S50: establishing a corrosion rate computing model, and combining the corrosion reaction rate constant with an environmental correction factor;
S60: computing an instantaneous corrosion rate according to the corrosion rate computing model;
S70: performing smoothing processing on the instantaneous corrosion rate using a moving time window method to obtain a steady-state corrosion rate; and
S80: computing a corrosion depth according to the steady-state corrosion rate, and performing a corrosion warning judgment.

2. The apparatus for detecting the corrosion rate of the soil-covered storage tank after cathodic protection of claim 1, wherein the corrosion rate computing module further comprises a step S90: updating a historical database for subsequent corrosion trend analysis.

3. The apparatus for detecting the corrosion rate of the soil-covered storage tank after cathodic protection of claim 2, wherein the guide rods are fixedly connected between the two limit plates and have a cylindrical structure with smooth surfaces, while the moving plate is slidably connected to an outer side of the guide rods and slidably engages with the guide rods through built-in bearings.

4. The apparatus for detecting the corrosion rate of the soil-covered storage tank after cathodic protection of claim 3, wherein sealing strips made of rubber material are arranged on both sides of the guard plate and closely adhere to the outer surface of the tank body, while the guard plate is fixed to the ground by fixing bolts and matches the tank body in length.

5. The apparatus for detecting the corrosion rate of the soil-covered storage tank after cathodic protection of claim 4, wherein a limit protrusion is arranged on an outer side of the threaded sleeve, a limit groove cooperating with the limit protrusion is arranged on the moving plate, and the limit protrusion and the limit groove cooperate to prevent rotation of the threaded sleeve.

6. The apparatus for detecting the corrosion rate of the soil-covered storage tank after cathodic protection of claim 5, wherein the motor is a stepper motor with an adjustable rotational speed, the stepper motor is fixed to an inner wall of the guard plate via a motor mount, the motor mount employs an anti-vibration structure, and a coupling is arranged between an output shaft of the stepper motor and the threaded rod.

7. The apparatus for detecting the corrosion rate of the soil-covered storage tank after cathodic protection of claim 6, wherein the bases employ a reinforced concrete structure, an anti-slip pattern is arranged on top surfaces of the bases, the bases are fixedly connected to the ground by expansion bolts, and a height of the bases is not less than 50 cm.

8. The apparatus for detecting the corrosion rate of the soil-covered storage tank after cathodic protection of claim 7, wherein the cleaning brush comprises a brush body having a rectangular cuboid structure, and bristles uniformly distributed on a surface of the brush body, wherein the bristles are made of corrosion-resistant nylon material, the brush body is fixedly connected to an inner surface of the arc-shaped plate by screws, and a length of the bristles is set according to a roughness of the surface of the tank body.

9. The apparatus for detecting the corrosion rate of the soil-covered storage tank after cathodic protection of claim 8, wherein the computing chip is arranged inside the guard plate.
